(19) United States
(12) Patent Application Publication
(10) Pub. No.: US 2009/0095822 A1
(43) Pub. Date: Apr. 16, 2009

(54) SPRAY HEAD FOR SPRAY BOTTLE

(76) Inventors: Kwok-Fai Chen, Hong Kong (CN); Kwok-Keung Chan, Hong Kong (CN)

Correspondence Address: KWOK-FAI CHEN, P.O. BOX 3-161, BANCIAO, TAIPEI COUNTY, 22099, TW

(21) Appl. No.: 11/872,712

(22) Filed: Oct. 16, 2007

(51) Int. Cl. B05B 1/02

(52) U.S. Cl. 239/302

(57) ABSTRACT

A spray head suitable for a spray bottle is provided. The spray head has a container and a lid covering the container. The container communicates with the interior of the bottle. The lid of the spray head which is secured to the bottle may be opened and water or fluid may be filled into the bottle by charging the water or fluid into container of the spray head.

### BACKGROUND OF THE INVENTION

1. Field of the invention

The present invention generally relates to a spray head. More particularly, the present invention relates to a spray head including a container for charging water or fluid into the bottle without removing the spray head from the bottle.

2. Description of Related Art

To fill water or fluid into a general spray bottle, the spray head is unscrewed and then removed from the bottle, and after filling the water or fluid into the bottle, the spray head is secured back to the bottle. This causes inconvenience in using the spray bottle.

### SUMMARY OF THE INVENTION

Accordingly, the present invention provides a spray head, which allows filling of water or fluid into the bottle without removing the spray head. Thus, this provides greater convenience, saves time and effort in using the spray bottle.

In accordance with the above objective and other objectives of the present invention, a spray head suitable for a spray bottle is provided. The spray head comprises a container and a lid covering the container. The container communicates with the interior of the bottle. The lid of the spray head which is secured to the bottle may be opened and water or fluid may be filled into the bottle by charging the water or fluid into container of the spray head.

### BRIEF DESCRIPTION OF THE DRAWING

For a more complete understanding of the present invention, reference will now be made to the following detailed description of preferred embodiments taken in conjunction with the following accompanying drawings.

FIG. 1 is a perspective view according to an embodiment of the present invention.

FIG. 2 is a view of an embodiment showing while filling water or fluid into the spray head according to the present invention.

FIG. 3A and 3B are exploded views of the spray head according to an embodiment of the present invention.

### DESCRIPTION OF THE INVENTION

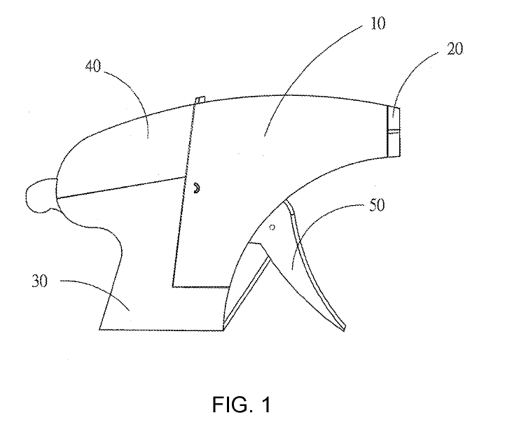

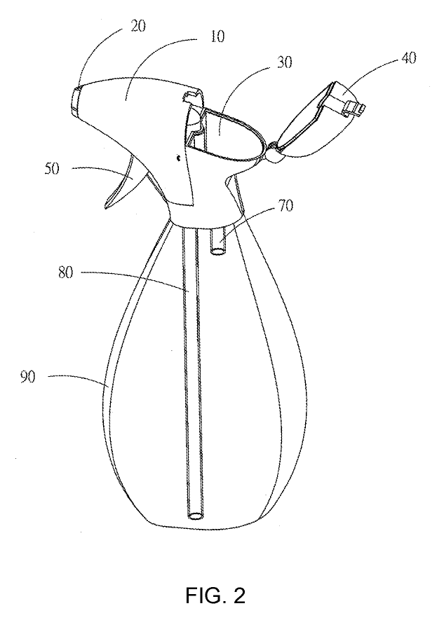

FIG. 1 is a perspective view according to an embodiment of the present invention. FIG. 2 is a view of an embodiment showing while filling water or fluid into the spray head according to the present invention. Referring to FIGS. 1 and 2, the spray bottle comprises a housing 10, a nozzle 20, a container 30, a lid 40 and a handle 50.

The container 30 is connected to a rear portion of the housing 10. The lid 40 covers the container 30. The handle 50 is positioned at a lower side of the housing 10 and connected to the container 30. The nozzle 20 is connected to the frontal side of the housing 10.

To charge water or fluid into the container 30, the lid 40 is opened and the water or fluid is filled into container 30 so that water or fluid enters into the bottle 90 through an inlet tube 70 that extend into the interior of the bottle 90. After the water or fluid is filled up to a desired level, the lid 40 is closed to prevent the water or fluid from leaking out. To spray out the water or fluid from the bottle 90, the handle 50 may be pressed to suck the water or fluid into the housing 10 via the outlet tube 80 and then sprayed out from the nozzle 20.

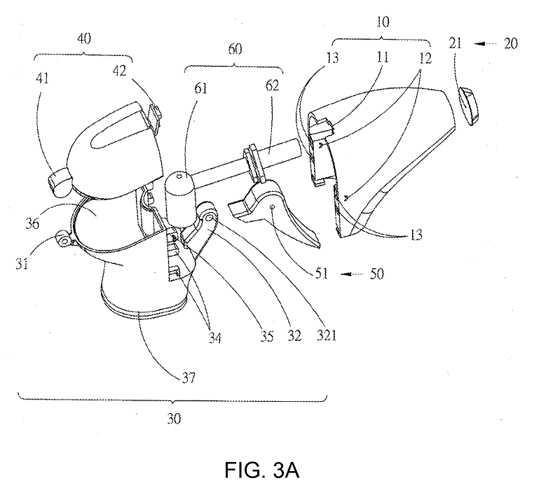

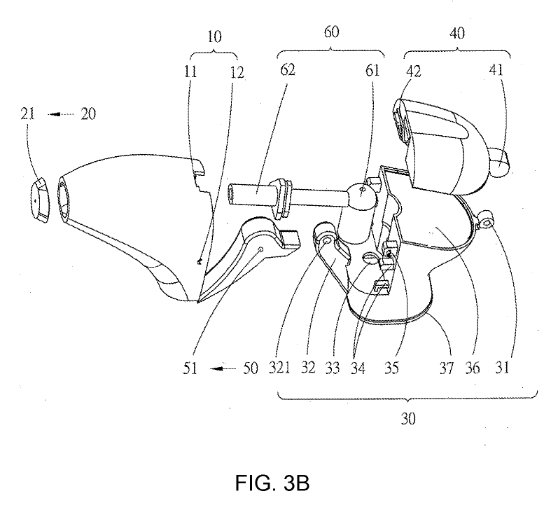

FIGS. 3A and 3B are exploded views of the spray head according to an embodiment of the present invention. Referring to FIGS. 3A and 3B, the spray bottle comprises a container 30, a lid 40, a housing 10, a nozzle 20, a tube 60 and a handle 50.

The lid 40 comprises an elastic plate 42 at an end thereof and a positioning portion 41 at another end thereof. The housing 10 is a hollow element and comprises a stopper 11 at an upper flange of a rear end thereof, a buckling portion 12 formed at two inner sides thereof and two corresponding indentations 13 formed at the rear end thereof. The nozzle 20 is a hollow element and comprises a nozzle tip 21. The tube 60 comprises an inlet 61 formed at an end thereof and an outlet 62 at another end thereof. The handle 50 comprises a pair of positioning holes 51 formed at an end thereof. The container 30 comprises a lid 37 positioned at a bottom of the container 30 for connecting to the bottle 90, an inlet 36 connected to the upper portion of an end of the lid 37, a buckling portion 31 connected to the upper flange of an end of the inlet 36, a pressing portion 32 connected to the upper portion of another end of the lid 37 which comprises a pair of positioning portions 321 at a frontal end thereof, a tube chamber 33 connected to an upper portion of the lid 37 and a bottom portion of the pressing portion 32, two corresponding protrusions 34 corresponding to the indentations 13 of the housing 10 and connected to the two ends of a side of the inlet 36, a hook 35 corresponding to the buckling portion 12 of the housing 10 and connected to the two ends of a side of the inlet 36.

The rear end of the nozzle 20 is connected to a frontal end of the housing 10, and the outlet 62 of the tube 60 is fit from the inner side of the housing 10 towards the opening at the frontal end and positioned protruding from the inner side of the nozzle 20, and the inlet 61 of the tube 60 is fit into the tube chamber 33 of the container 30. Furthermore, the protrusion 34 of the container 30 is fit into the indentation 13 and to buckle the hook 35 of the container 30 to the buckling portion 12 respectively. The positioning portion 321 of the pressing portion 32 of the container 30 is fit into the positioning hole 51 of the handle 50. The buckling portion 31 of the container 30 positioned with the positioning portion 41 of the lid 40 to jam the elastic plate 42 of the lid 40 with the stopper 11 of the housing 10.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A spray head suitable for a spray bottle, comprising
a container,
a lid, covering the container;
an inlet, extending from a bottom of the lid;
at least a buckling portion, connecting to an upper flange of an end of the inlet, a pressing portion connecting to an upper end of another end of the lid and having a positioning portion, a tube chamber connected to an upper portion of the lid and a bottom portion of the pressing portion, and at least one protrusion connecting to two sides of a side of said inlet;
a lid, having an elastic plate at an end thereof and a positioning portion at another end thereof, wherein the positioning portion is connected to a buckling portion of the container;
a hollow housing, including a stopper, at least a pair of buckling portion corresponding to said buckling portion, and a pair of indentations corresponding to protrusions of said container, wherein said stopper is positioned at an upper flange of a rear end of the hollow housing for jamming the elastic plate of the lid, the buckling portion is positioned at two inner side of a rear end of the housing to buckle said hook of the container, and an indentation is positioned at two inner sides of a rear end of said housing to securely positioned to protrusion of the container;
a nozzle, comprising at least a nozzle tip formed at a frontal end thereof and connected to a frontal end of the housing;
a tube, having an inlet formed at an end thereof and an outlet thereof connected to the nozzle; and
a handle, having a pair of positioning holes at an end thereof for positioning the positioning portion of a pressing portion thereof.
